(19) United States
(12) Patent Application Publication
(10) Pub. No.: US 2004/0118001 A1
(43) Pub. Date: Jun. 24, 2004

(54) Combined laser level tape for fence construction

(76) Inventor: Larry Wayne Turpin, Escondido, CA (US)

Correspondence Address: Donald W. Meeker, Patent Agent, Law Office of John E. Engel, 950 Vista Village Dr., Vista, CA, 92084, US

(21) Appl. No.: 10/327,204

(22) Filed: Dec. 20, 2002

(51) Int. Cl. G01B 3/10

(52) U.S. Cl. 33/760

(57) ABSTRACT

A combined laser, level, and tape measure has a magnetic edge for attaching to metal fence posts for use in obtaining accurate measurements of the drop and gait needed for constructing a fence on a sloping terrain. It is configured with the laser emitter on the top for generating a laser beam perpendicular to the fist post along which the device is moved to align the laser beam with the ground point at a second post spaced apart from the first at a higher elevation. A measuring tape positioned baselined to the laser and positioned at the bottom of the device is drawn down to measure the distance from the laser beam to the ground, which is equal to the drop in elevation between the two posts.

### BACKGROUND OF THE INVENTION

1. Field of the Invention

The present invention relates to measuring devices and in particular to a combined laser, level, and tape measure with a magnetic edge for attaching to metal fence posts for use in obtaining the exact drop and gait for constructing a fence for a sloping terrain.

2. Description of the Prior Art

When a fence is being installed on uneven ground there is a need to install the support posts in a vertical orientation and then measure the drop and gait accurately to enable the construction of the sloping rails and vertical posts inbetween the support posts.

Numerous devices have been developed to assist in the measurement and checking of site contours and elevations. The elevations of landmarks are, in the majority of cases, surveyed by means of a linear measuring instrument that requires the presence of two operators using complex and sensitive equipment. Such an operation is tedious, long and expensive. Moreover, the surveying done by two operators is conducted at the beginning of a project to determine the site topography. The survey instruments are not practical for quickly and easily checking grade levels and contours. For quick on-site use, the device should be small, self-contained, portable and easy-to-use by one person.

While a number of prior patents provide levels, including those with laser beams, none are configured for work in obtaining accurate measurements for constructing a fence on sloping ground.

Prior art U.S. Pat. No. 5,421,094, issued Jun. 6, 1995 to McCord, provides an adjustable level having an angled base with legs extending normal to one another from a common edge and with magnets spaced along and extending fully through each leg; an L-shaped bracket having at least one bubble housing fixed to a leg thereof; a post extending from the base and through a hole in the bracket; a spring on the post and between a head on the post and the bracket to bias the bracket towards the base and to thereby engage ribs on the bracket into grooves on the base; and a retainer for retaining the level to objects, including a flexible cord connected to a return spring and a loop and hook to secure the cord in a pulled out condition surrounding an object.

Prior art U.S. Pat. No. 4,663,856, issued May 12, 1987 to Hall, shows a kit that is primarily designed to facilitate the construction of a fence with vertical posts and horizontal rails. The kit includes a leveling/plumbing device having a central level for indicating a horizontal position, and an end level for indicating a vertical position. The device is attachable to a workpiece being positioned, by separable fasteners of the hook and loop type. The user can then use two hands to position the workpiece while observing the desired one of the levels.

Prior art U.S. Pat. No. 6,389,709, issued May 21, 2002 to Lunde, claims an apparatus used for checking elevation between reference markers. The apparatus includes a measuring device (e.g., a tape measure) that can measure the distance from an elevated location to the ground immediately below the location. A sighting device and a leveling device (e.g., a hand level) are secured to the distance-measuring device so that a remote reference marker can be sighted. The distance-measuring device is calibrated such that it measures the distance from the ground to the centerline of the sighting device.

Prior art U.S. Pat. No. 5,894,675, issued Apr. 20, 1999 to Cericola, describes a new combination tool for use in measuring, leveling, squaring, and plumbing operations. The inventive device includes a housing adapted to encase a tape measure including an extendible and retractable tape and adapted to encase a laser source capable of projecting a visible light beam, wherein the extendible and retractable tape is extendible from the housing and the visible light beam is projectable from the housing perpendicular to the extendible and retractable tape. A horizontal bubble-leveling vial and a vertical bubble-leveling vial are mounted on the housing for leveling thereof in horizontal and vertical planes.

Prior art U.S. Pat. No. 6,029,359, issued Feb. 29, 2000 to Szumer, discloses a post level that includes a pair of arms pivotally attached to each other at a hinge, each arm defining at least one level face for plumbing a surface, and at least one bubble vial mounted on at least one of the arms on a surface generally opposite to the at least one level face, wherein the arms may be swung about the hinge so as to be positioned generally parallel with each other with the at least one bubble vial being between the arms.

Prior art U.S. Pat. No. 6,209,219, issued Apr. 3, 2001 to Wakefield, indicates a measuring device that includes a housing; a distance measuring apparatus carried on the housing, one or more housing orientation indicators, and a focused light beam source. Using the housing orientation indicators, the housing can be properly oriented so that a focused light beam emitted by the focused light beam source will illuminate a point on a remote surface to accurately transfer the position of the housing to the remote surface.

Prior art U.S. Pat. No. 6,223,446, issued May 1, 2001 to Potter, puts forth a small, simple and easy-to-use elevation checking and measuring device that can also be used to measure points to the same level as a known point. The invention comprises a primary housing and secondary casing, which contains tape-measuring blades. The primary housing has opposing sidewalls, each of which may include a vertical slot. The slots are designed to mate with projections extending from the secondary casing. The slots and projections provide alternative angular orientations of the housing and casing when connected together. The primary housing contains level indicators to determine when it is held level. It also includes a light source that illuminates a target at the end of the primary housing blade. Maintaining the beam on the target while using the level indicators to achieve a horizontal orientation of the primary assembly, thereby permits a user to make quick and accurate grade or height measurements with the tape measure blades.

Prior art U.S. Pat. No. 4,976,040, issued Dec. 11, 1990 to Mish, concerns an apparatus for indicating and proper positioning of a post, including a first and second spirit level member, with a first elastic band securing the first and second spirit level together, and a second elastic band directed exteriorly of the second spirit level member, including a loop securable to a hook mounted to the first spirit level member to encompass a post. The elastic bands each include flexible magnetic members mounted coextensively with the elastic bands, and further including apertures directed through the first and second bands to receive fasteners, such as nails, to selectively mount the organization to the post by utilization of fasteners, magnetic attraction, or frictional elastic encompassing of an associated post.

What is needed is a small, self-contained, portable level and measuring tool which is easy-to-use by one person

### SUMMARY OF THE INVENTION

An object of the present invention is to provide a combined laser, level and tape measure in one measuring device for accurate measure of the drop in elevation between fence support posts.

Another object of the present invention is to provide a magnetic side which allows the invention to be attached to a first metal support post with easy vertical movement until the laser is aligned with the second support post where it meets the ground.

One more object of the present invention is to provide a tape measure that is attached to the device, set so that the zero point of the measurement is horizontally aligned with the laser beam.

An additional object of the present invention is to provide a level that is used to align a first support post vertically.

A contributory object of the present invention is to provide a horizontal laser beam that shines in a perpendicular direction from one post to another, thereby allowing the user to view the difference in elevation between the first and second support posts.

A further object of the present invention is to provide a device in which one person can perform the measuring operation very quickly and easily.

An added object of the present invention is to provide a small, self-contained, portable level and measuring tool.

In brief, the present invention comprises a combined laser, level, and tape measure in a unique configuration for measuring related to fence construction. The device has an elongated measuring instrument having a magnetized edge along the length of the device to attach along the side of a vertical support post of a metal fence. The level vial being transversely oriented on the device is used to align a first support post vertically with the level attached to the side of the first support post. The level is moved vertically on the first post until a horizontal laser beam shines on a low point of a second support post, which is at a higher elevation, where the second post meets the ground. A vertical measuring tape baselined to the laser beam stretches to the ground where the first support post meets the ground. This measurement provides the drop, or the difference in elevation between the ground at the first support post and the ground at the second support post. Knowing the bias or distance along the ground between the support posts as they were installed and the difference in elevation, provides an accurate measurement of the drop and gait to enable the metal fence rails and intermediate posts to be custom made for that segment between the first and second support posts. The device is a small, self-contained, portable level and measuring tool that allows one person to perform the measuring operation very quickly and easily.

An advantage of the present invention is in providing an accurate measurement of the drop and gait used in fence construction.

Another advantage of the present invention is that is attaches to a metal fence support post with easy vertical movement until the laser is aligned with the area where the second support post meets the ground.

One more advantage of the present invention is that one person can use the invention to measure the drop from the lower post support.

An additional advantage of the present invention is in providing a level that is used to align a support post vertically.

Another advantage of the present invention is that it allows the user to view the difference in elevation between the first and second support posts.

A further advantage of the present invention is in providing a device in which one person can perform the measuring operation very quickly and easily.

An added advantage of the present invention is that it is a small, self-contained, portable level and measuring tool.

Yet another advantage of the present invention is to enable metal fence rails and intermediate posts to be custom made.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a side elevational view of the combined laser, level, and tape measuring device of the present invention;

FIG. 2 is a side elevational view of the invention of FIG. 1 shown mounted on a first vertical metal fence support post with the laser beam aimed at the point where a second vertical metal fence support post meets the ground which is higher in elevation than the point at which the first post meets the ground.

### BEST MODE FOR CARRYING OUT THE INVENTION

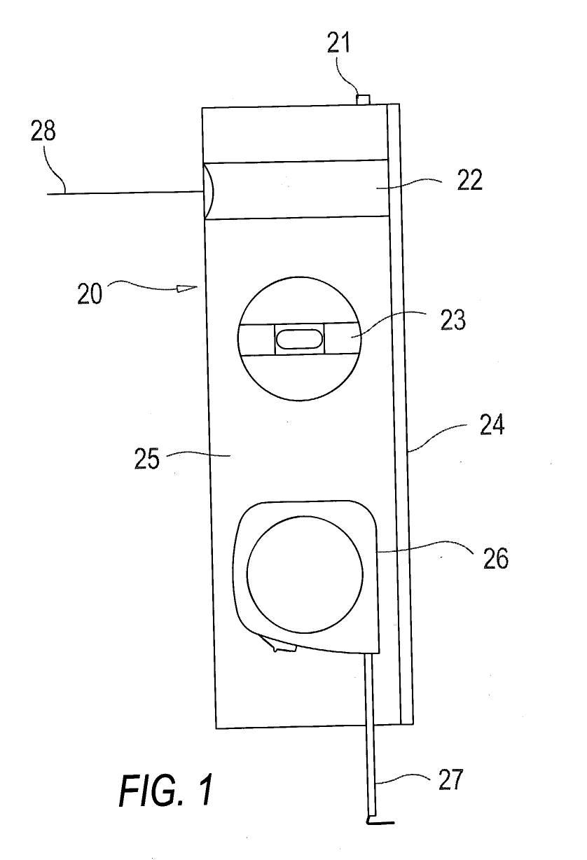

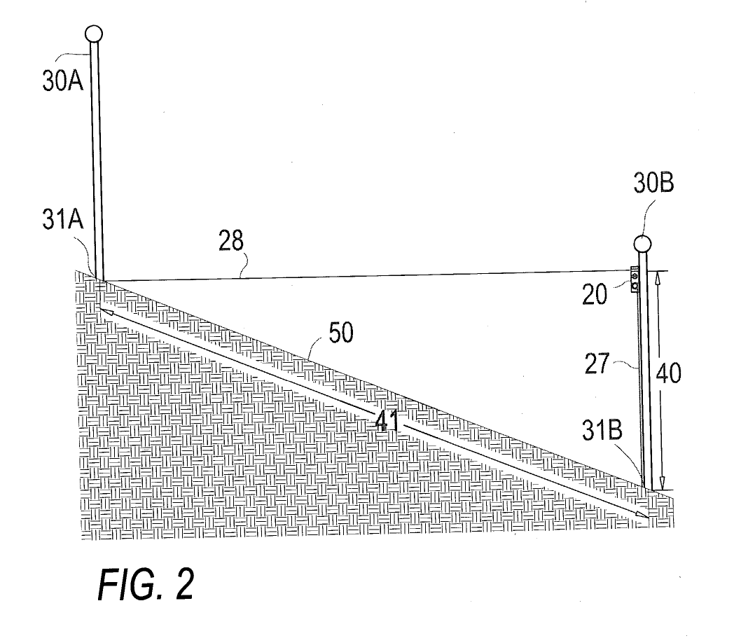

In FIGS. 1 and 2, a topographic measuring device 20 is shown which is for determining a difference 40 in elevation between two points 31A and 31B, the ground contact points of two vertical support posts 30A and 30B. The device 20 comprises an elongated body 25, a magnet 24, a laser generator 22, a retractable tape measure 26, and a level 23. The elongated body 25 has at least one flat side with a magnet 24 along the length of the body 25, the flat side capable of being positioned against a first external vertical element 30B so that the elongated body 25 is capable of sliding along the first external vertical element 30B which is in contact 31B with the ground 50. The external vertical elements, the metal fence support posts 30A and 30B, have at least one metallic surface capable of attraction to the magnet 24, thereby being capable of magnetically attaching to the first external vertical element, the support post 30B.

A laser beam generator diode laser emitter 22 mounted on the body 25 is capable of generating a horizontal beam of laser light 28. The laser beam generator 22 is mounted on the elongated body 25 so that the laser beam 28 is perpendicular to the flat face having the attached magnet 24 of the elongated body 25. The elongated body 25 being positioned vertically allows the laser beam 28 which is generated on a side of the elongated body 25 opposite to the flat face, to be capable of being beamed at a point of a second vertical external element, the fence support post 30A, in contact with the ground at a ground contact point 31A and spaced apart from the first external vertical element, the fence support post 30B.

The device 20 has a measuring means that comprises a retractable tape measure 26. The retractable tape measure 26 is mounted adjacent to a bottom end of the elongated body 25 so that a tape 27 of the retractable tape measure 26 is capable of being drawn downwardly to the ground below the device 20. The tape 27 is calibrated so that the measurement 40 includes the distance between a point of reading the measurement and the laser beam 28, so that the distance or drop 40 between the laser beam 28 and the ground contact point 31B of the fence support post 30B.

The level indicating means 23, preferably a bubble vial level, is mounted transversely on the elongated body 25, and is capable of showing when the elongated body 25 is positioned vertically with the at least on flat side being vertical to insure the vertical orientation of the first external vertical element, the fence support post 30B.

In FIG. 2, a distance measuring means, a tape measure 26, is shown mounted on the elongated body 25. The distance measuring means 26 is calibrated with the laser beam 28 as the zero base line, and is capable of measuring the distance, called the “drop” 40, between the laser beam 28 and a point on the ground 31B where the external vertical element 30B meets the ground 50. The drop 40 between the ground elevation 31B at the first external vertical element 30B and the ground elevation 31A at the second external vertical element 30A is then capable of being measured when the laser beam 28 is aligned with the ground point 31A at the second external vertical element, the support post 30A, at a higher elevation than the ground contact point 31B of the first support post 30B.

The external vertical elements 30A and 30B are metal fence support posts set in the ground 50 a measured distance 41 apart, this measurement being called the “bias” 41. The measurement of the differences in ground elevation 40 between support posts 30A and 30B allows the drop and gait of the fence to be determined, thereby enabling the fabrication of a section of fence between the support posts 30A and 30B.

In practice, the topographic measuring device 20 is mounted with the magnet 24 attached to a first metal fence support post 30B, turned on by means of a switch 21, and moved vertically until the laser beam 28 is pointed at a second support post 30A at the ground point 31A. The tape measure 27 would then be pulled to the ground point 31B of the first post 30B to measure the distance of the difference in elevation 40 from the laser 22 to the ground 50, which distance 40 is called the “drop” 40. The distance 41 between posts 30A and 30B along the ground 50 is called the “bias” 41. By measuring the drop 40 and using the already known bias 41 between the two posts 30A and 30B, the portion of the fence between the posts 30A and 30B can be constructed accurately. Because of the sloping ground, the rails of a fence would not be perpendicular to the vertical elements 30A and 30B, and the angle could be determined from the measurements using geometry. By dividing the drop 40 by the number of spaces between the support posts required for the fence, the elevation needed for each fence section can be determined, making each one lower than the next by the “gait”.

The invention is especially adapted for use in fabricating metal fences, such as wrought iron fences.

It is understood that the preceding description is given merely by way of illustration and not in limitation of the invention and that various modifications may be made thereto without departing from the spirit of the invention as claimed.

What is claimed is:

1. A topographic measuring device for determining a difference in elevation between two points, the device comprising
an elongated body having at least one flat side along the length of the body, the flat side capable of being positioned against a first external vertical element so that the elongated body is capable of sliding along the first external vertical element which vertical element is in contact with the ground;
a laser means mounted on the body, the laser means capable of generating a horizontal beam of laser light with the elongated body positioned vertically, the laser beam being generated on a side of the elongated body opposite to the at least one flat side, the laser beam being capable of being beamed at a point of a second vertical external element in contact with the ground and spaced apart from the first external vertical element;
a level indicating means mounted on the body, the level indicating means capable of indicating when the elongated body is positioned vertically with the at least on flat side being vertical to insure the vertical orientation of the first external vertical element;
a distance measuring means mounted on the elongated body, the distance measuring means calibrated with the laser beam as the zero base line, the distance measuring means capable of measuring the distance between the laser beam and a point on the ground where the external vertical element meets the ground, so that the difference between the ground elevation at the first external vertical element and the ground elevation at the second external vertical element is capable of being measured when the laser beam is aligned with the ground point at the second external vertical element.

2. The device of claim 1 wherein the external vertical elements have at least one metallic surface capable of attraction to a magnet and the elongated body further comprises a magnet means attached to the at least one flat side, the device thereby being capable of magnetically attaching to the first external vertical element.

3. The device of claim 2 wherein the external vertical elements are metal fence support posts set in the ground a measured distance apart so the measurement of the differences in ground elevation between support posts enables the drop and gait of the fence to be determined to enable fabricating a section of fence between the support posts.

4. The device of claim 1 wherein the laser means is a laser beam generator mounted on the elongated body so that the laser beam is generated perpendicular to the at least one flat face of the elongated body.

5. The device of claim 1 wherein the measuring means comprises a retractable tape measure mounted adjacent to a bottom end of the elongated body so that a tape of the retractable tape measure is capable of being drawn downwardly to the ground below the device and the tape is calibrated so that the measurement includes the distance between a point of reading the measurement and the laser beam.
